(19) United States
(12) Patent Application Publication
(10) Pub. No.: US 2021/0168397 A1
(43) Pub. Date: Jun. 3, 2021

(54) Systems and Methods for Learning Video Encoders

(71) Applicants: Nicolai OTTO, Wiesbaden, DE (US); Frank SCHOENBERGER, Simmerath, DE (US); NEULION, LLC, Plainview, NY (US)

(72) Inventors: Nicolai Otto, Wiesbaden (DE); Frank Schoenberger, Simmerath (DE)

(21) Appl. No.: 17/051,128

(22) PCT Filed: Apr. 15, 2019
(86) PCT No.: PCT/US2019/027516

§ 371 Date: Oct. 27, 2020

Related U.S. Application Data
(63) Continuation of application No. 15/964,534, filed on Apr. 27, 2018, now abandoned.

(51) Int. Cl. H04N 19/52; H04N 19/172; H04N 19/577; G06F 16/35

(52) U.S. Cl. CPC H04N 19/52; H04N 19/172; G06N 20/00; G06F 16/35; H04N 19/577

(57) ABSTRACT

Systems and methods provide learning video encoding in accordance with embodiments of the invention, In one embodiment, a method for encoding multimedia content includes receiving video data using a media server system, analyzing the video data to identify at least one piece of frame data using the media server system, providing the at least one piece of frame data to a machine learning classifier using the media server system, where the machine learning classifier receives predicts a set of characteristics of the video data based on the at least one piece of frame data, obtaining a set of encoding parameters from the machine learning classifier using the media server system, and encoding the video data based on the set of encoding parameters using the media server system.

### FIELD OF THE INVENTION

The present invention generally relates to video streaming and more specifically relates to digital video systems with predictive video encoders.

### BACKGROUND

The term streaming media describes the playback of media on a playback device, where the media is stored on a server and continuously sent to the playback device over a network during playback. Typically, the playback device stores a sufficient quantity of media in a buffer at any given time during playback to prevent disruption of playback due to the playback device completing playback of all the buffered media prior to receipt of the next portion of media. Adaptive bit rate streaming or adaptive streaming involves detecting the present streaming conditions (e.g. the user's network bandwidth and CPU capacity) in real time and adjusting the quality of the streamed media accordingly. Typically, the source media is encoded at multiple bit rates and the playback device or client switches between streaming the different encodings depending on available resources.

Adaptive streaming solutions typically utilize either Hypertext Transfer Protocol (HTTP), published by the Internet Engineering Task Force and the World Wide Web Consortium as RFC 2616, or Real Time Streaming Protocol (RTSP), published by the Internet Engineering Task Force as RFC 2326, to stream media between a server and a playback device. HTTP is a stateless protocol that enables a playback device to request a byte range within a file. HTTP is described as stateless, because the server is not required to record information concerning the state of the playback device requesting information or the byte ranges requested by the playback device in order to respond to requests received from the playback device. RTSP is a network control protocol used to control streaming media server systems. Playback devices issue control commands, such as “play” and “pause”, to the server streaming the media to control the playback of media files. When RTSP is utilized, the media server system records the state of each client device and determines the media to stream based upon the instructions received from the client devices and the client's state.

In adaptive streaming systems, the source media is typically stored on a media server system as a top level index file pointing to a number of alternate streams that contain the actual video and audio data. Each stream is typically stored in one or more container files. Different adaptive streaming solutions typically utilize different index and media containers. The Synchronized Multimedia Integration Language (SMIL) developed by the World Wide Web Consortium is utilized to create indexes in several adaptive streaming solutions including IIS Smooth Streaming developed by Microsoft Corporation of Redmond, Wash., and Flash Dynamic Streaming developed by Adobe Systems Incorporated of San Jose, Calif. HTTP Adaptive Bitrate Streaming developed by Apple Computer Incorporated of Cupertino, Calif. implements index files using an extended M3U playlist file (.M3U8), which is a text file containing a list of URIs that typically identify a media container file. The most commonly used media container formats are the MP4 container format specified in MPEG-4 Part 14 (i.e. ISO/IEC 14496-14) and the MPEG transport stream (TS) container specified in MPEG-2 Part 1 (i.e. ISO/IEC Standard 13818-1). The MP4 container format is utilized in IIS Smooth Streaming and Flash Dynamic Streaming. The TS and MP4 container is used in HTTP Adaptive Bitrate Streaming.

The Matroska container is a media container developed as an open standard project by the Matroska non-profit organization of Aussonne, France. The Matroska container is based upon Extensible Binary Meta Language, which is a binary derivative of the Extensible Markup Language. Decoding of the Matroska container is supported by many consumer electronics devices. The DivX Plus file format developed by DivX, LLC of San Diego, Calif. utilizes an extension of the Matroska container format (i.e. is based upon the Matroska container format, but includes elements that are not specified within the Matroska format).

### SUMMARY OF THE INVENTION

Systems and methods provide learning video encoding in accordance with embodiments of the invention. In one embodiment, a method for encoding multimedia content includes receiving video data using a media server system, analyzing the video data to identify at least one piece of frame data using the media server system, providing the at least one piece of frame data to a machine learning classifier using the media server system, where the machine learning classifier receives predicts a set of characteristics of the video data based on the at least one piece of frame data, obtaining a set of encoding parameters from the machine learning classifier using the media server system, and encoding the video data based on the set of encoding parameters using the media server system.

In yet another additional embodiment of the invention, the set of encoding parameters includes a bitrate and a resolution.

In still another additional embodiment of the invention, the machine learning classifier is selected from the group consisting of decision trees, k-nearest neighbors, support vector machines, and neural networks.

In yet still another additional embodiment of the invention, the neural network further includes a recurrent neural network.

In yet another embodiment of the invention, calculating the set of characteristics of the video data further includes extracting a feature from the video data using the media server system,

In still another embodiment of the invention, extracting the feature includes extracting the feature by performing a process selected from the group consisting of principal component analysis, independent component analysis, isomap analysis, convolutional neural networks, and partial least squares.

In yet still another embodiment of the invention, the machine learning classifier further uses the feature from the video data as an input.

In yet another additional embodiment of the invention, the method further includes calculating a feature in the set of characteristics of the video data using the media server system,

In still another additional embodiment of the invention, the method further includes training the machine learning classifier using the encoded video data.

In yet still another additional embodiment of the invention, training the machine learning classifier further includes adjusting the machine learning classifier based on differences between the set of characteristics of the video data and a set of characteristics in a similar piece of video data.

In yet another embodiment of the invention, the machine learning classifier is saved locally on the media server system.

In still another embodiment of the invention, the machine learning classifier is saved remotely on a remote server system.

In yet still another embodiment of the invention, the video data is captured from a live video stream.

Still another embodiment of the invention includes a media server system including a processor and a memory in communication with the processor and storing a learning video encoding application, wherein the video encoding application directs the processor to receive video data, analyze the video data to identify at least one piece of frame data, provide the at least one piece of frame data to a machine learning classifier, where the machine learning classifier receives predicts a set of characteristics of the video data based on the at least one piece of frame data, obtain a set of encoding parameters from the machine learning classifier, and encode the video data based on the set of encoding parameters.

In yet another additional embodiment of the invention, the set of encoding parameters includes a bitrate and a resolution.

In still another additional embodiment of the invention, the machine learning classifier is selected from the group consisting of decision trees, k-nearest neighbors, support vector machines, and neural networks.

In yet still another additional embodiment of the invention, the processor calculates the set of characteristics of the video data by extracting a feature from the video.

In yet another embodiment of the invention, extracting the feature includes extracting the feature by performing a process selected from the group consisting of principal component analysis, independent component analysis, isomap analysis, convolutional neural networks, and partial least squares.

In still another embodiment of the invention, the machine learning classifier is saved locally on the media server system.

In yet still another embodiment of the invention, the machine learning classifier is saved remotely on a remote server system.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the claims.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 is a diagram conceptually illustrating a network diagram of an adaptive bitrate streaming system in accordance with an embodiment of the invention.

FIG. 2A is a diagram conceptually illustrating a playback device of an adaptive bitrate streaming system in accordance with an embodiment of the invention.

FIG. 2B is a diagram conceptually illustrating a server system configured to encode streams of video data for use in an adaptive bitrate streaming system in accordance with an embodiment of the invention.

FIG. 2C is a block diagram conceptually illustrating a media server system configured to encode streams of video data for use in adaptive streaming systems in accordance with an embodiment of the invention.

FIG. 3 is a flowchart illustrating a process for learning video encoding in accordance with an embodiment of the invention.

FIG. 4 is a flowchart illustrating a process for learning video encoding based on motion data in accordance with an embodiment of the invention.

FIG. 5 is a flowchart illustrating a process for learning video encoding based using global training data in accordance with an embodiment of the invention.

### DETAILED DESCRIPTION

Turning now to the drawings, systems and methods for learning video encoding in accordance with embodiments of the invention are illustrated. Video encoding is a process of compressing and/or converting digital video from one format to another. Single pass encoding analyzes and encodes data on the fly and is typically the preferred method for real time encoding. In a single pass encoding example, portions of the input data are analyzed as they are received by the encoder as additional and/or future portions of the video stream are generally unavailable. In a typical single pass encoding, a variety of parameters can be adjusted to encode individual frames under conservative assumptions to ensure the video stream does not exceed a peak bitrate. The immediate encoding of video data makes single pass encoding well suited for streaming media applications. Multi pass encoding analyzes and encodes data in several passes. In a two pass encoding example, a type of multi pass encoding, the input data can be analyzed in a first pass and the data collected in the first pass can be used in encoding during the second pass to achieve a higher encoding quality. Multi pass encoding generally uses the entire data file when performing passes of the data. In contrast to single pass encoding, multi pass encoding typically involves calculating how many bits are required for future frames in the video stream. This knowledge can be used to adjust the number of bits made available to a current frame during video encoding. Accessing the entire data file many times can have a variety of disadvantages and/or the entire file can simply be unavailable in some circumstances for example (but not limited to) during live streaming media applications. Any of a variety of media types can be streamed in a streaming media application including (but not limited to) video, audio, interactive chats, and/or video games.

Learning video encoding processes in accordance with embodiments of the invention can be used to achieve the quality advantages of multi pass encoding while having the speed advantages of single pass encoding. That is, learning video encoding processes allow for encoding video efficiently (by improving the prediction of upcoming frames) without having to make multiple passes over the video. In various embodiments, learning video encoding processes can include making predictions about characteristics of future video using machine learning classifiers and adjusting encoder parameters based on these predictions. Encoding parameters can include any elements within an encoder that will change the resulting encoded video. Knowledge of future video characteristics can increase overall encoding metrics in many embodiments of the invention by preemptively adjusting encoding parameters in anticipation of the future video segment. For example, encoding parameters can determine how many bits to allocate to the frame. In variety of embodiments of the invention, characteristics of future frames and/or a sequence of future frames can be predicted by a machine learning classifier using a single frame and/or a sequence of frames. The Encoding parameters can be adjusted using these characteristics of future frames under less conservative assumptions than a typical single pass encoding system as the predicted knowledge of future frames can be utilized in a manner similar to knowledge of future frames in a multi pass encoding system.

Learning video encoding processes can be performed by learning video encoders to make predictions about future video. Learning video encoding processes can use any of a variety of machine learning classifiers for these predictions. Characteristics in a particular frame or in the video segments, such as (but not limited to) information that can be used to adjust one or more encoding parameters and/or patterns in video segments (often referred to as features), can be predicted. In some embodiments, learning video encoders include training machine learning classifiers to make such predictions through supervised learning. Any of a variety of different machine learning classifiers can be trained using machine learning processes to be utilized in learning video encoding processes as appropriate for specific applications of embodiments of the invention. A known video sequence, such as a training set of video segments and/or frames of video, can be utilized to train the machine learning classifier. A frame and/or sequence of frames can be provided to the machine learning classifier as appropriate to the requirements of specific applications of embodiments of the invention. Once the machine learning classifier is trained using the training data, the learning video encoder can utilize the machine learning classifier to predict characteristics in future video sequences and/or patterns in future video sequences using frames and/or video sequences in the video data. When the future video sequence characteristics are correctly predicted, information collected from the encoding of the video sequence can be used to predict video characteristics in other video data correctly, In many embodiments, the correctly classified video data can be added to the training set to improve the performance of the machine learning classifier. Similarly, information related to incorrectly predicted future video characteristics can be added to the training data set to improve the precision of the machine learning classifier. Incorrect predictions can be based on a variety of metrics including (but not limited to) an objective quality measure, encoding that violates a maximum bitrate requirement, encoding that diverges significantly from the video during the encoding process when a multi pass encoding system is utilized, and/or a combination of incorrect prediction metrics as appropriate to the requirements of specific applications of embodiments of the invention. In many embodiments, machine learning classifiers can be trained to predict characteristics of future video frames and/or sequences of frames. For example, a live sports broadcast (or any other video broadcast) might reuse typical edit sequences, camera motions, camera angles, color settings, and/or edit sequences that can be learned by a machine learning classifier.

Learning video encoders can also be utilized to encode a single piece of video data at a variety of resolutions, frame rates, and/or bit rates, thereby providing a number of alternative streams of encoded video data that can be utilized in adaptive streaming systems. Systems and methods for adaptive streaming system and learning encoding processes in accordance with a variety of embodiments of the invention are described in more detail below.

### Adaptive Streaming Systems

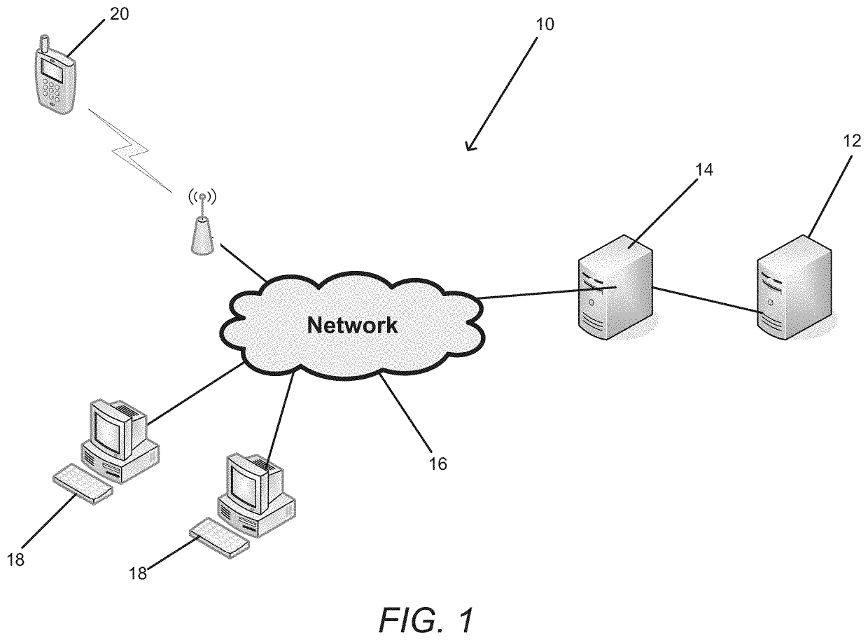

In many embodiments, video data can be encoded and/or played back in a variety of systems, such as adaptive streaming systems, utilizing a variety of learning video encoding processes. Turning now to the FIG. 1, an adaptive streaming system including playback devices that provide real time video streaming in accordance with an embodiment of the invention is illustrated. The adaptive streaming system 10 includes a source encoder 12 configured to encode source media as a number of alternative streams. In the illustrated embodiment, the source encoder is a server. In other embodiments, the source encoder can be any processing device including a processor and sufficient resources to perform the transcoding of source media (including but not limited to video, audio, and/or subtitles). Typically, the source encoding server 12 generates a top level index to a plurality of container files containing the streams and/or metadata information, at least a plurality of which are alternative streams. Alternative streams are streams that encode the same media content in different ways. In many instances, alternative streams encode media content (such as, but not limited to, video content and/or audio content) at different maximum bitrates. In a number of embodiments, the alternative streams of video content are encoded with different resolutions and/or at different frame rates. The top level index file and the container files are uploaded to an HTTP server 14. A variety of playback devices can then use HTTP or another appropriate stateless protocol to request portions of the top level index file, other index files, and/or the container files via a network 16 such as the Internet.

In the illustrated embodiment, playback devices include personal computers 18, consumer electronic devices, and mobile phones 20. Consumer electronics devices include a variety of devices such as DVD players, Blu-ray players, televisions, set top boxes, video game consoles, tablets, and other devices that are capable of connecting to a server and playing back encoded media. Although a specific architecture for an adaptive streaming system is shown in FIG. 1, any of a variety of architectures including systems that perform conventional streaming and not adaptive bitrate streaming can be utilized that enable playback devices to obtain encoded video for playback in accordance with embodiments of the invention.

### Playback Devices and Server Systems

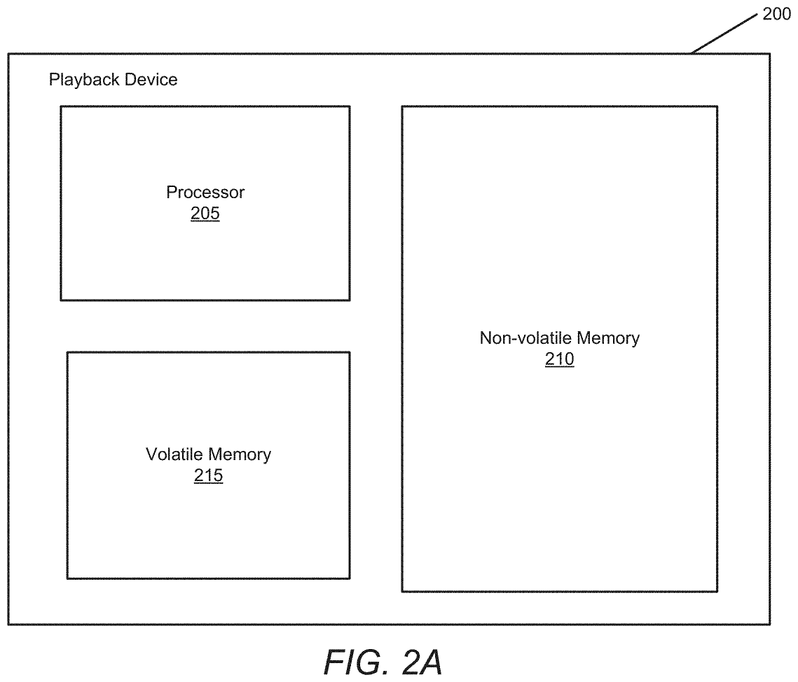

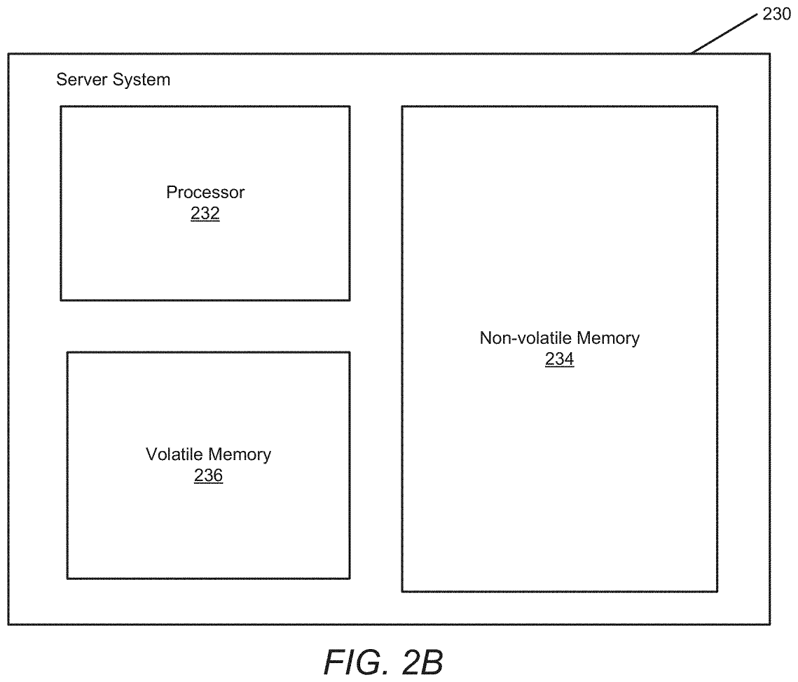

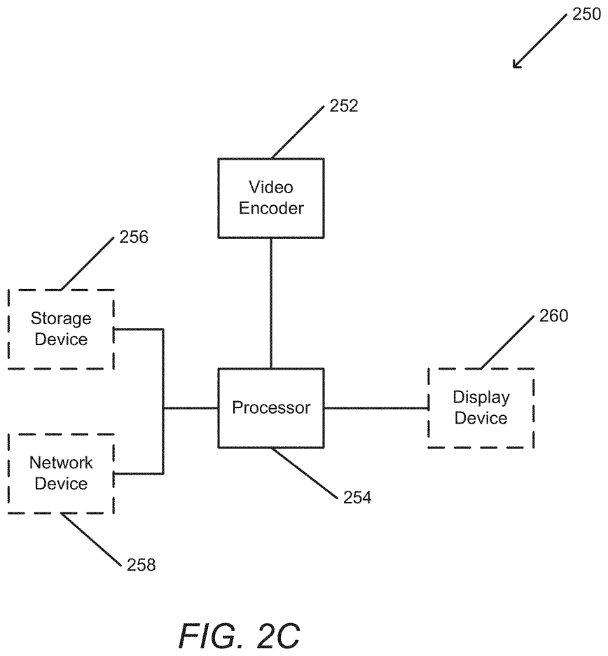

A conceptual illustration of a playback device that can perform processes in accordance with an embodiment of the invention are shown in FIG. 2A. One skilled in the art will recognize that playback device may include other components that are omitted for brevity without departing from described embodiments of this invention. The playback device 200 includes a processor 205, a non-volatile memory 210, and a volatile memory 215. The processor 205 can be a processor, microprocessor, controller, or a combination of processors, microprocessor, and/or controllers that performs instructions stored in the volatile memory 215 or non-volatile memory 210 to manipulate data stored in the memory as appropriate to the requirements of specific applications of embodiments of the invention. The non-volatile memory 210 can store the processor instructions utilized to direct the processor 205 to perform a variety of learning video encoding processes in accordance with embodiments of the invention. In accordance with some embodiments, these instructions are included in a playback application that performs the playback of media content on a playback device. In accordance with various embodiments, the playback device software and/or firmware can be stored in any of a variety of non-transitory computer readable media appropriate to a specific application.

A number of learning video encoding processes in accordance with various embodiments of this invention can be executed by an HTTP server, source encoding server, and/or local and network time server systems. The relevant components in a server system that performs one or more of these learning video encoding processes in accordance with embodiments of the invention are shown in FIG. 2B. One skilled in the art will recognize that a server system may include other components that are omitted for brevity without departing from the described embodiments of this invention. The server system 230 includes a processor 232, a non-volatile memory 234, and a volatile memory 236. The processor 232 can be a processor, microprocessor, controller, or a combination of processors, microprocessor, and/or controllers that performs instructions stored in the volatile memory 236 or non-volatile memory 234 to manipulate data stored in the memory. The non-volatile memory 234 can store the processor instructions utilized to configure the server system 230 to perform a variety of learning video encoding processes in accordance with embodiments of the invention. In accordance with some embodiments, instructions to perform encoding of media content are part of an encoding application. In accordance with various embodiments, the server software and/or firmware can be stored in any of a variety of non-transitory computer readable media appropriate to a specific application.

A block diagram of a media server system in accordance with an embodiment of the invention is illustrated in FIG. 2C. The media server system 250 can include a storage device 256 connected to a processor 254 and a video encoder 252. The processor 254 can be configured to encode a plurality of streams of video data given a source video. In a number of embodiments, the video encoder 252 can be implemented in hardware. In several embodiments, the video encoder 252 can be implemented utilizing a graphics processing unit. In many embodiments, the video encoder 252 can be a software application that configures the processor 254 to encode alternative streams of video data using any of a variety of learning video encoding processes. In a number of embodiments, the media server system 250 can include a storage device 256 connected to the processor 254 to store multimedia content, alternative streams of video data, and/or additional parameters relevant to encoding including, but not limited to, machine learning classifiers for use in learning video encoding processes. In several embodiments, the media server system 250 can include a display device 260 connected to the processor 254. The display device 260 can be used to display streams of video data and/or information related to the encoding of video data using machine learning classifiers. In accordance with various embodiments, the media server system 250 can utilize one or more servers systems configured with software applications to encode and/or stream media content as appropriate to specific requirements of particular embodiments of the invention. The media server system 250 can further include a network device 258 connected to the processor 254. The network device 258 can establish a network connection for the processor 254 to stream media content for use in adaptive streaming systems.

Although specific architectures for playback devices, server systems, and media server systems are described with respect to FIGS. 2A-C, any of a variety of systems including hardware devices and/or software other than those specifically illustrated can be utilized in accordance with embodiments of the invention.

### Learning Video Encoding

Learning video encoders can perform a variety of learning video encoding processes to analyze incoming video data, identify characteristics within the video data, utilize machine learning classifiers to adjust encoding parameters for encoding the video data, and encode the video data as appropriate to the requirements of specific applications of embodiments of the invention. The encoding of the video data can be performed on the entire stream and/or the video data can be divided into a number of video segments and the encoding of the video data can be performed on each video segment. The key characteristics can be identified, and the encoding parameters set, on a frame-by-frame basis and/or using groups of frames as appropriate to the requirements of specific applications of embodiments of the invention.

In a variety of embodiments, video data is pre-recorded. In several embodiments of the invention, video data can be received from a source video stream. The source video stream content can include (but is not limited to) a live sports game, a concert, a lecture, a video game, and/or any other live streaming event. Source content can include many individual components including (but not limited to) video, audio, subtitles, and/or other data relevant to the source stream. Identified characteristics in the video data can include the amount and type of noise in the video frames, the content type, and a variety of other parameters. Choosing encoding parameters for learning video encoding includes analyzing characteristics of the current video segment and/or sequence of video segments. Characteristics of a future video segment can be predicted using the characteristics of the current video segment and or sequence of video segments.

Features (or patterns) can optionally be extracted from the video data. Feature extraction can combine the amount of data in the received video data and/or characteristics of the received video data by making meaningful combinations of the data (i.e. combining features in the data) in a way that still gives an accurate description of the data. In many embodiments of the invention, feature extraction techniques can include (but are not limited to) principal component analysis, independent component analysis, isomap analysis, convolutional neural networks, and/or partial least squares.

In many embodiments, the machine learning classifier is trained with training data to set up basic categories of characteristics and/or motion patterns. Once trained, the learning video encoder can use the machine learning classifier to automatically analyze and categorize incoming video frames. In a variety of embodiments, the characteristics and encoding decisions and results can be stored in a learning database or similar means of storage with the goal of automatically selecting and improving encoding settings for future encodes based on past learning data. Training data sets can include, but are not limited to, video streams encoded by multi pass encoding processes. In many embodiments, a previously trained machine learning classifier can be utilized by a learning video encoder. It should be readily apparent to one having ordinary skill in the art that a variety of machine learning classifiers can be utilized including (but not limited to) training of decision trees, k-nearest neighbors, support vector machines, neural networks (NN), recurrent neural networks (RNN), convolutional neural networks (CNN), and/or probabilistic neural networks (PNN). RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In some embodiments of the invention, supervised learning processes can be used to train the classifier. In other embodiments, a combination of classifiers can be utilized, more specific classifiers when available, and general classifiers at other times can further increase the accuracy of predictions.

The machine learning classifier can predict characteristics of future video segments and/or extracted features within the video data based on frame data, where the frame data can be a single frame and/or a group of frames related to the video segment. In a number of embodiments, the machine learning classifier identifies similar frame data and utilizes the characteristics of the similar frame data to make predictions regarding upcoming video segments and/or optimal encoding parameters for encoding the video segment. In some embodiments, only the most recent frame data and/or its corresponding features is used by the machine learning classifier. In a number of embodiments, multiple video segments and/or pieces of frame data can be used such as (but not limited to) the entire video data and/or a defined recent portion of the video data. In many embodiments, the number of video segments and/or pieces of frame data used by the machine learning classifier to predict future characteristics can dynamically change based on the accuracy of past and/or future predictions, for example (but not limited to) using more video segments when prediction accuracy fall below a user defined threshold and/or decreasing the number of video segments used by the machine learning classifier when prediction accuracy is above a certain threshold.

In some embodiments, feature extraction can be used on the video data and/or video segments prior to classification of the video data. Feature extraction can reduce the amount of data processed by a machine learning classifier by combining variables or features in a meaningful way that still accurately describes the underlying video data. It should readily be appreciated to one having ordinary skill in the art that many feature extraction techniques are available such as (but not limited to) principal component analysis, independent component analysis, isomap analysis, convolutional neural networks, and/or partial least squares, and feature extraction itself is optional. In various embodiments, knowledge of current encoding parameters can be used during feature selection. In several embodiments, knowledge of streaming media can be used in feature extraction, for example (but not limited to) camera motion, player motion in a sports game, and/or typical edit sequences.

Encoding parameters can be adjusted based on predictions from the machine learning classifier. In several embodiments, encoding parameters can include (but are not limited to) bitrate, resolution, video codec, audio codec, video frame rate, audio bit rate, audio sample rate, block size parameters, intra prediction parameters, inter prediction parameters, transform parameters, inverse transform parameters, quantization parameters, inverse quantization parameters, rate control parameters, motion estimation parameters, and/or motion compensation parameters. The adjustment of the encoding parameters can include modifying existing encoding parameters and/or replacing existing encoding parameters with parameters provided by the machine learning classifier as appropriate to the requirements of specific applications of embodiments of the invention.

With the encoding parameters set, the video data and/or video segment can be encoded. Video data can be encoded in any of a variety of formats as appropriate to the requirements of specific applications of embodiments of the invention, including MPEG-1 (ISO/IEC 11172-2), MPEG-2 (ISO/IEC 13818-2 and ITU-T H.262), MPEG-4 Part 2 (ISO/IEC 14496-2 and ITU-T H.263), AVC/MPEG-4 Part 10 (ISO/IEC 14496-10 and ITU-T H.264), HEVC (ISO/IEC 23008-2 and ITU-T H.265), VP8, VP9, AV1 JPEG-2000 (ISO/IEC 15444-1 and 2), SMPTE VC-3, DNxHR, DNxHD, and ProRes (SMPTE RDD-36). In a variety of embodiments, the encoding parameters are adjusted for one or more segments of video in the video data.

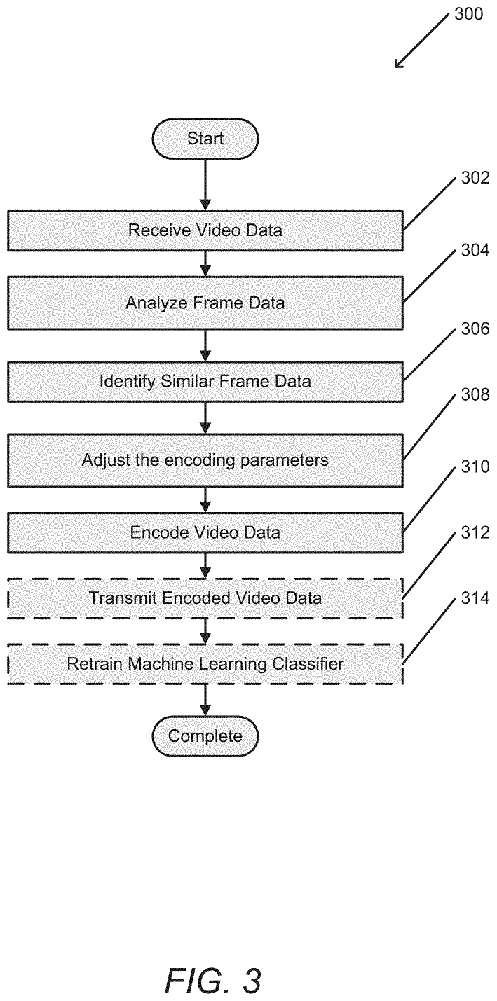

Turning now to FIG. 3, a process for encoding video data using a learning video encoder in accordance with an embodiment of the invention is shown. The process 300 includes receiving (302) video data. Frame data is analyzed (304) and similar frame data is identified (306). Encoding parameters are adjusted (308) and video data is encoded (310), In several embodiments, the encoded video data is transmitted (312) and/or the machine learning classifier is retrained (314).

It is possible (and likely) that a video encoder is presented with very similar type of frames. For example, sporting events typically include particular configurations of camera motion and/or background characteristics, such as stadium seating and the court. In a second example, surveillance cameras are typically installed in a fixed location, In such a scenario, machine learning classifiers can recognize given patterns or frames and adjust the encoding parameters based on past data having similar patterns. A variety of learning encoding processes include encoding video data having a variety of motion patterns. Motion patterns can include, camera tilts, zoom, lateral movement, and any other motion captured in the video data as appropriate to the requirements of specific applications of embodiments of the invention. Learning encoding processes can include observing the background part of the image, combining it with the attributes of foreground images (e.g. a table or a person), and making predictions about the future behavior and position of the objects relative to the background. Returning to the examples, this may mean that the environment to be monitored and the motion of the camera within the environment will always be similar, allowing the learning video encoder to reach high amount of precision and allowing the encoding to focus on patterns or parts of video frames with change (for example, a customer entering a shop or a play on a sporting field) as the machine learning classifier can quickly identify changes in a particular frame (or group of frames) when particular background characteristics and/or typical motions are known.

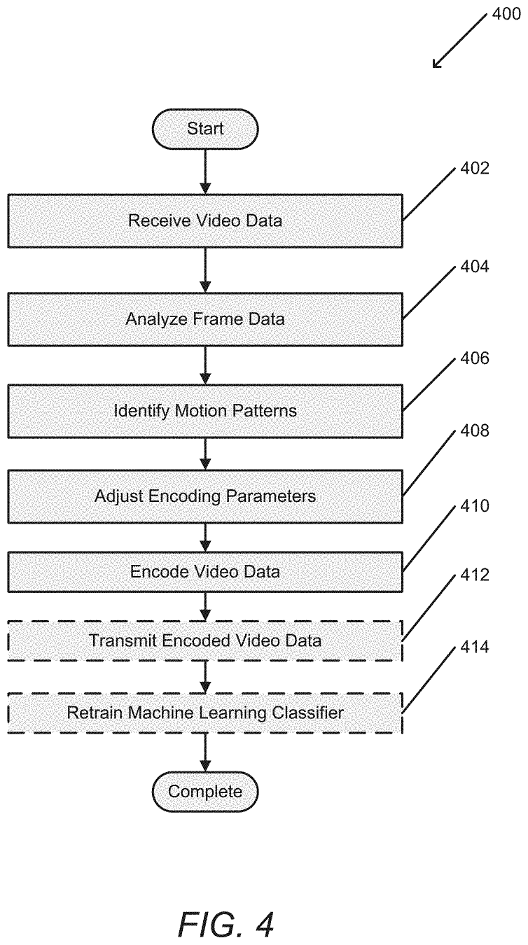

Turning now to FIG. 4, a process for learning video encoding based on motion data in accordance with an embodiment of the invention is shown. The process 400 includes receiving (402) video data, analyzing (404) frame data, and identifying (406) motion patterns. Encoding parameters are adjusted (408) and video data is encoded (410). In several embodiments, encoded video data is transmitted (412) and/or the machine learning classifier is retrained (414).

Although particular processes for encoding video using machine learning classifiers are described with respect to FIGS. 3 and 4, any of a variety of processes, including those that utilize machine learning classifiers other than those described and those that utilize other features of the video data than those described, can be performed in accordance with the requirements of specific applications of embodiments of the invention.

### Global Machine Learning Classifiers

In a variety of embodiments, learning video encoders are capable of exchanging training data utilized by the machine learning classifiers. A variety of learning video encoding processes including storing training data in a manner that can be exchanged between learning video encoders. In many embodiments, the training data can be saved locally to the media server system where the video data is being encoded. In a number of embodiments, training data can be saved on a remote server system and accessed through a network connection, The global training data can be accessed by many learning video encoders, in both open and closed networks, for training machine learning classifiers. This allows transfer of training data between systems, thereby reducing training time for specific machine learning classifiers. In many embodiments, the machine learning classifiers themselves are hosted on a remote server system and a variety of learning video encoder can request the remote machine learning classifier classify a particular piece of video data and/or video segment.

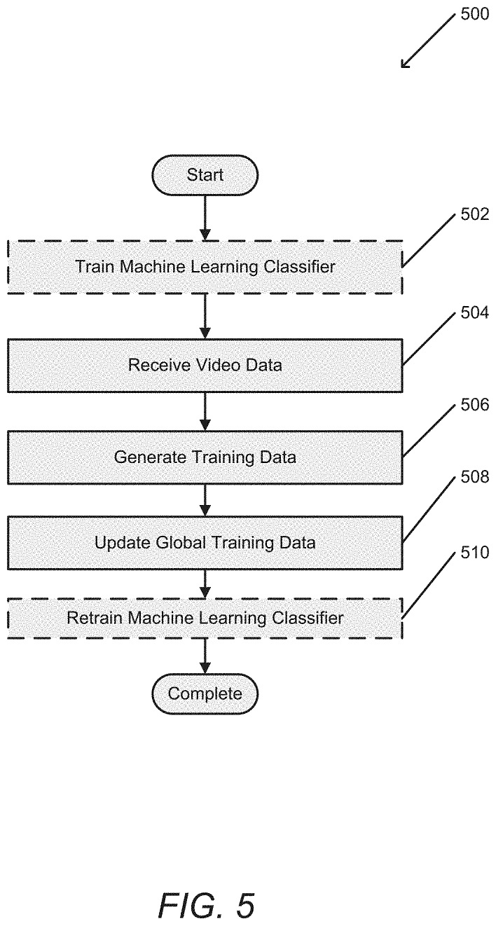

Turning now to FIG. 5, a process for learning video encoding based using global training data in accordance with an embodiment of the invention is shown. The process 500 can include training (502) a machine learning classifier using global training data. Video data is received (504) and training data is generated (506). In many embodiments, the generated (506) training data is generated using processes similar to those described with respect to FIGS. 3 and 4. Global training data is updated (508) and, in several embodiments, the machine learning classifier is retrained (510)

Specific process for encoding video data using global machine learning classifiers in accordance with embodiment of the inventions is discussed with respect to FIG. 5; however, any of a variety of processes capable of learning about past video streams to generate better encoding for future video may be utilized in accordance with embodiments of the invention.

Although the present invention has been described in certain specific aspects, many additional modifications and variations would be apparent to those skilled in the art. In particular, any of the various processes described herein can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It will be evident to the person skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled person, except where expressly required. Accordingly, the scope of the invention should be determined not by the embodiments illustrated, but by the appended claims and their equivalents.

What is claimed

1. A method for encoding multimedia content comprising:
receiving video data using a media server system;
analyzing the video data to identify at least one piece of frame data using the media server system;
providing the at least one piece of frame data to a machine learning classifier using the media server system, where the machine learning classifier receives predicts a set of characteristics of the video data based on the at least one piece of frame data;
obtaining a set of encoding parameters from the machine learning classifier using the media server system; and
encoding the video data based on the set of encoding parameters using the media server system.

2. The method of claim , wherein the set of encoding parameters comprises a bitrate and a resolution.

3. The method of claim 1, wherein the machine learning classifier is selected from the group consisting of decision trees, k-nearest neighbors, support vector machines, and neural networks. The method of claim 3, wherein the neural network further comprises a recurrent neural network.

5. The method of claim 1, wherein calculating the set of characteristics of the video data further comprises extracting a feature from the video data using the media server system.

6. The method of claim 5, wherein extracting the feature comprises extracting the feature by performing a process selected from the group consisting of principal component analysis, independent component analysis, isomap analysis, convolutional neural networks, and partial least squares.

7. The method of claim 6, wherein the machine learning classifier further uses the feature from the video data as an input.

8. The method of claim 7, further comprising calculating a feature in the set of characteristics of the video data using the media server system.

9. The method of claim 1, further comprising training the machine learning classifier using the encoded video data.

10. The method of claim 9, wherein training the machine learning classifier further comprises adjusting the machine learning classifier based on differences between the set of characteristics of the video data and a set of characteristics in a similar piece of video data.

11. The method of claim 1, wherein the machine learning classifier is saved locally on the media server system.

12. The method of claim 1, wherein the machine learning classifier is saved remotely on a remote server system.

13. The method of claim 1, wherein the video data is captured from a live video stream.

14. A media server system, comprising:
a processor; and
a memory in communication with the processor and storing a learning video encoding application;
wherein the video encoding application directs the processor to:
receive video data;
analyze the video data to identify at least one piece of frame data;
provide the at least one piece of frame data to a machine learning classifier, where the machine learning classifier receives predicts a set of characteristics of the video data based on the at least one piece of frame data;
obtain a set of encoding parameters from the machine learning classifier, and
encode the video data based on the set of encoding parameters.

15. The media server system of claim 14, wherein the set of encoding parameters comprises a bitrate and a resolution.

16. The media server system of claim 14, wherein the machine learning classifier is selected from the group consisting of decision trees, k-nearest neighbors, support vector machines, and neural networks.

17. The media server system of claim 14, wherein the processor calculates the set of characteristics of the video data by extracting a feature from the video.

18. The media server system of claim 17, wherein extracting the feature comprises extracting the feature by performing a process selected from the group consisting of principal component analysis, independent component analysis, isomap analysis, convolutional neural networks, and partial least squares.

19. The media server system of claim 14, wherein the machine learning classifier is saved locally on the media server system.

20. The media server system of claim 14, wherein the machine learning classifier is saved remotely on a remote server system.
